(19) United States
(12) Patent Application Publication
(10) Pub. No.: US 2014/0319152 A1
(43) Pub. Date: Oct. 30, 2014

(54) MULTI-PURPOSE COOKING VESSEL AND METHOD OF MANUFACTURING THE SAME

(71) Applicant: Kim Tae Suck, Dalseong-gun (KR)

(72) Inventor: Kim Tae Suck, Dalseong-gun (KR)

(21) Appl. No.: 14/246,651

(22) Filed: Apr. 7, 2014

(30) Foreign Application Priority Data
Apr. 24, 2013 (KR) 10-2013-0045630

(51) Int. Cl. A47J 27/00

(52) U.S. Cl. CPC A47J 27/00; A47J 27/002
USPC 220/573.1; 29/428

(57) ABSTRACT

A multi-purpose cooking vessel and a method of manufacturing the vessel are provided. The vessel includes: a body having a concave shape; and a handle attached to the body. The body includes: a flat bottom plate; and a sidewall formed on the circumference of the bottom plate. The sidewall includes: a lower sidewall which is formed from the circumference of the bottom plate and is extended upwardly and rounded externally; and an upper sidewall which is extended upwardly from the top of the lower sidewall and bent rounded internally toward inside of the body. The top edge is inclined such that the height of the upper sidewall gradually increases from a first side of the body toward a second side of the body located opposite to the first side. An opening portion of the top of the sidewall is formed to have a circle shape.

### RELATED APPLICATIONS

This application claims the benefit of Korean Patent Application No. 10-2013-0045630, filed on Apr. 24, 2013, in the Korean Intellectual Property Office, the disclosure of which is incorporated herein in its entirety by reference.

### BACKGROUND

1. Field

One or more embodiments of the present invention relate to a multi-purpose cooking vessel and a method of manufacturing the cooking vessel, and more particularly, to a cooking vessel which can be used for multiple purposes, such as a frying pan, a stir fry pan, a roasting pan, a pot, etc., and a method of manufacturing the cooking vessel.

2. Description of the Related Art

Generally, cooking vessels are used for cooking food and according to purposes, those can be classified into frying pans, stir fry pans, roasting pans, pots, etc.

A conventional cooking vessel has a circular bottom plate and a sidewall formed on the circumference of the bottom plate with a predetermined height, and on the external surface of the sidewall, one or two handles are attached. Among the cooking vessels, the frying pan has a shape in which a bottom plate is wide and the sidewall is low, and the stir fry pan and the roasting pan have a shape in which the sidewall is higher than that of the frying pan. The pot which is used to boil or simmer food has a sidewall higher than those of the stir fry pan and the roasting pan, and basically uses a lid to reduce heat loss and prevent overflow of food. Depending on the type or cooking method, frying pans, stir fry pans, and roasting pans sometimes use lids.

When food is cooked using a frying pan or a roasting pan, cooking utensils such as a scoop or a turner may be used to flip foods or evenly mix foods. In this case, food may overflow outside the cooking vessel.

In order to prevent this problem, the sidewall may be made to be higher. However, in this case, the higher sidewall may be an obstacle in using a turner or scoop. Also, even though the sidewall of a cooking vessel is high, it does not mean turning food becomes easier.

### SUMMARY

One or more embodiments of the present invention include a cooking vessel which can be used for multiple purposes, such as a frying pan, a stir fry pan, a roasting pan, a pot, etc., and has a shape in which turning food is easier and overflow of food is prevented, and a method of manufacturing the cooking vessel.

Additional aspects will be set forth in part in the description which follows and, in part, will be apparent from the description, or may be learned by practice of the presented embodiments.

According to one or more embodiments of the present invention, a cooking vessel includes: a vessel body which has a concave shape; and a handle which is attached to the vessel body, wherein the vessel body includes: a bottom plate which is formed flat; and a sidewall which is formed on the circumference of the bottom plate, and the sidewall includes: a lower sidewall which is formed from the circumference of the bottom plate and is extended upwardly and rounded externally; and an upper sidewall which is extended upwardly from the top of the lower sidewall and bent rounded internally toward inside of the vessel body, and the top edge of the upper sidewall is formed inclined such that the height of the upper sidewall gradually increases from a first side of the vessel body toward a second side of the vessel body located opposite to the first side with respect to the center of the vessel body, and an opening portion of the top of the sidewall is formed to have a circle shape.

The lower sidewall of the first side of the vessel body may be formed to have a first radius of curvature and the lower sidewall of the second side of the vessel body may be formed to have a second radius of curvature which is greater than the first radius of curvature.

The upper sidewall may be formed to have a third radius of curvature which is less than the second radius of curvature.

The handle may be attached to the external surface of the first side of the vessel body, and a discharge spout for discharging food to the outside is formed close to the handle.

The angle between a first straight line which connects the center of the vessel body and the center of the handle, and a second straight line which connects the center of the vessel body and the center of the discharge spout may be between 30° and 60° inclusive.

According to one or more embodiments of the present invention, a method of manufacturing a cooking vessel with a vessel body which has a concave shape and a handle which is attached to the vessel body, includes: preparing a lower mold which has a convex lower pressing surface; preparing an upper mold which has a concave upper pressing surface whose shape corresponds to the shape of the convex lower pressing surface; placing a metal plate between the lower mold and the upper mold such that the center line of the metal plate is moved eccentrically from the center line of the lower mold; forming a vessel body by lowering the upper mold and thus pressing and transforming the metal plate in order to form the vessel body having a flat bottom plate and a sidewall formed on the circumference of the bottom plate, wherein the sidewall comprises: a lower sidewall which is formed from the circumference of the bottom plate and is extended upwardly and rounded externally; and an upper sidewall which is extended perpendicularly to the top of the lower sidewall and of which the top edge is formed inclined such that the height of the upper sidewall gradually increases from a first side of the vessel body toward a second side of the vessel body located opposite to the first side with respect to the center of the vessel body; processing the top portion of the sidewall of the vessel body to be inclined; bending the upper sidewall such that the upper sidewall is rounded internally toward the inside of the vessel body and an opening portion of the top of the sidewall has a circle shape; and attaching the handle to the vessel body.

The lower pressing surface of the lower mold may include: a flat surface portion which is flat; a curved surface portion which is extended downwardly and rounded from the circumference of the flat surface portion; and a vertical surface portion which is extended vertically and downwardly from the bottom of the curved surface portion.

The preparing of a lower mold may include: forming the flat surface portion by processing the top surface of a material for the lower mold to be flat; forming the vertical surface portion by processing the circumference of the material; and forming the curved surface portion by processing the material on the circumference of the flat surface portion to be rounded, and the forming of the curved surface portion comprises: a first processing for processing the material on the circumference of the flat surface portion to be rounded and have a first radius of curvature with respect to the center line of the lower mold; and a second processing for processing the material on the circumference of the flat surface portion to be rounded and have a second radius of curvature with respect to a center line which is moved eccentrically from the center line of the lower mold to a first side of the lower mold, and the second radius of curvature is greater than the first radius of curvature.

In a second side of the lower mold, the bottom of a second processing surface which is formed in the second processing may coincide with the bottom of the first processing surface which is formed in the first processing, and in the first processing, the flat surface portion may be limited to have a first diameter and in the second processing, and the flat surface portion may be reduced to have a second diameter which is shorter than the first diameter.

At the center of the upper mold, a core may be provided on a location corresponding to the flat surface portion of the lower pressing surface such that the core moves up and down, and in the forming of the vessel body, the core may immobilize the metal plate between the top surface of the lower mold and the bottom surface of the core.

The bending of the upper sidewall may include: preparing a lower bending mold which has a concave support surface supporting the vessel body; preparing an upper bending mold which has a concave bending surface for bending the upper sidewall; stably placing the vessel body on the support surface of the lower bending mold; and lowering the upper bending mold and thus pressing the upper sidewall of the vessel body with the bent surface such that the upper sidewall is bent rounded inwardly to the inside of the vessel body.

At the center of the upper bending mold, a core may be provided on a location corresponding to the bottom plate of the vessel body stably placed on the support surface of the lower bending mold, and in the bending of the upper sidewall, the core may press and immobilize the bottom plate of the vessel body.

The handle may be attached to the external surface of the first side of the vessel body, and before attaching the handle, a discharge spout for discharging food may be formed on the top edge of the sidewall close to the first side of the vessel body.

The cooking vessel according to the embodiments of the present invention can be used as a frying pan, a stir fry pan, or a roasting pan. Also, as the opening on the top of the sidewall has a circular shape, a lid may be used and thus the cooking vessel may be used as a pot.

Also, as the upper sidewall is formed to be bent rounded inwardly to the inside of the vessel body, spattering or overflowing of cooking oil or food may be prevented more efficiently.

Also, as the top edge of the sidewall of the vessel body is formed to be inclined, the sidewall does not prevent use of a turner or scoop and thus food can be cooked easily.

Also, as the lower sidewall located on the second side of the vessel body has a relatively longer second radius of curvature to be connected smoothly from the circumference of the bottom plate, food can be easily turned as long as the food inside the vessel body is pushed to the sidewall side by using a turner or scoop.

Also, as the heat transfer area is widened by the lower sidewall which is formed to have a gentle slope, food is evenly heated and cooked appropriately, and thus the taste of the food is improved.

Also, as a discharge spout is formed to be close to the first side of the vessel body which has the lowest height, if the vessel body is a little tilted in the direction of the handle and tilted a little in the direction of the first side, the food in the vessel body can be easily discharged to the outside through the discharge spout, and thus effort required for discharging food is reduced and user convenience increases.

Also, according to one example method of manufacturing the cooking vessel of the present embodiments, the opening portion on the top of the sidewall of the vessel body can be easily formed to be circular. Also, as the cutting amount of the sidewall of the vessel body is minimized, loss of material is reduced and the number of times of cutting processing is also reduced and thus, processing hours decrease and manufacturing costs decrease.

### BRIEF DESCRIPTION OF THE DRAWINGS

To explain the technical solutions of the examples of the present disclosure, accompanying drawings used in the examples are followed. Apparently, the following drawings merely illustrate some examples of the disclosure, but for persons skilled in the art, other drawings can be obtained without creative works according to these drawings.

Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

These and/or other aspects will become apparent and more readily appreciated from the following description of the embodiments, taken in conjunction with the accompanying drawings in which:

FIG. 1 is a perspective view of a multi-purpose cooking vessel according to an exemplary embodiment of the present invention;

FIG. 2 is a plan view of the cooking vessel shown in FIG. 1;

FIG. 3 is a side view of the cooking vessel shown in FIG. 2 with a lid on top;

FIG. 4 is a diagram showing a section of the vessel body according to A-A′ line shown in FIG. 2 together with the shape of an opening portion on the top of the sidewall;

FIGS. 5 through 8 are diagrams to explain comparison examples of a method of manufacturing the cooking vessel shown in FIGS. 1 through 4;

FIG. 9 is a sectional view of a lower mold and an upper mold to form the vessel body of the cooking vessel shown in FIGS. 1 through 4;

FIG. 10 is a diagram to explain a method of forming a lower pressing surface of the lower mold shown in FIG. 9;

FIG. 11 is a diagram showing a state in which a metal plate is pressed and transformed between the lower mold and the upper mold shown in FIG. 9;

FIG. 12 is a sectional view of the vessel body formed by the process shown in FIG. 11;

FIG. 13 is a diagram to explain a process for bending the top part of the sidewall of the vessel body shown in FIG. 12; and

FIG. 14 is a diagram showing a section of the vessel body and the shape of the opening portion on the top of the sidewall, completed through the bending process shown in FIG. 13.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

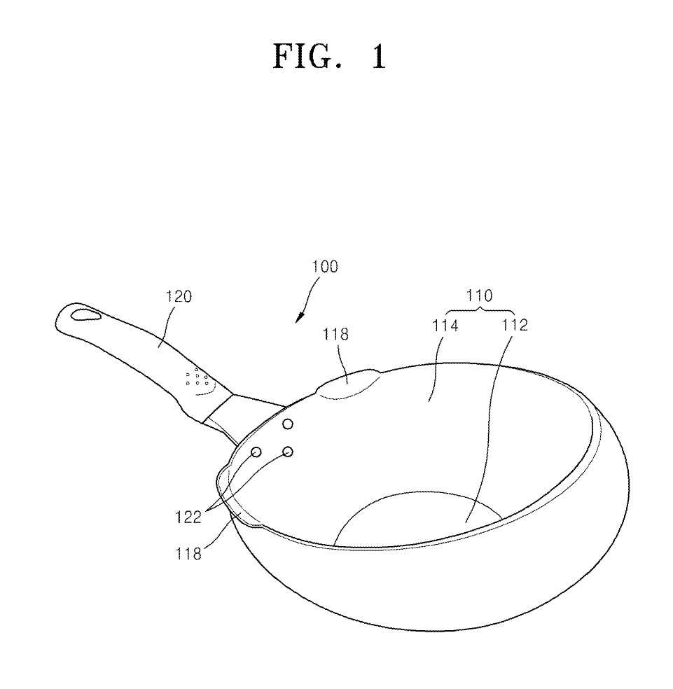

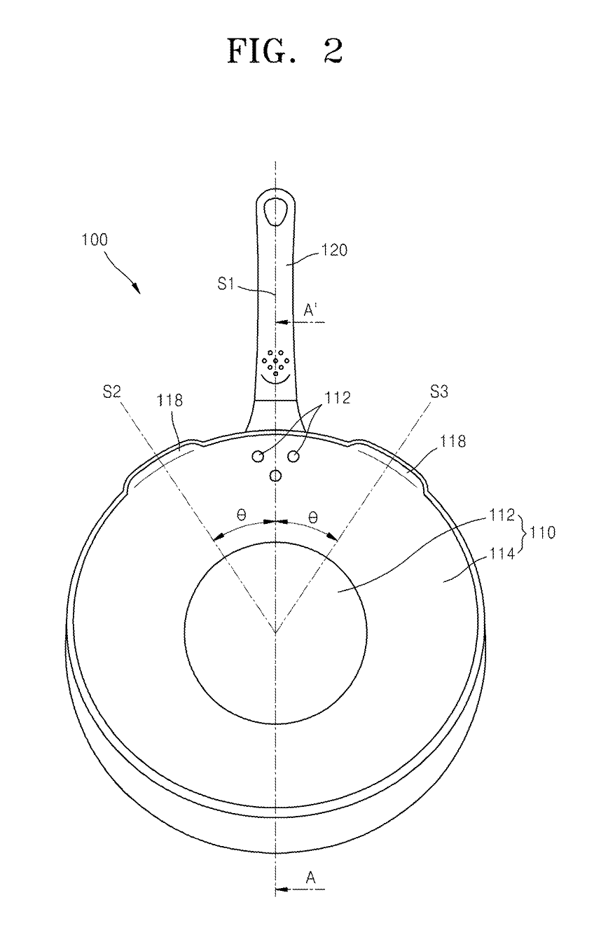

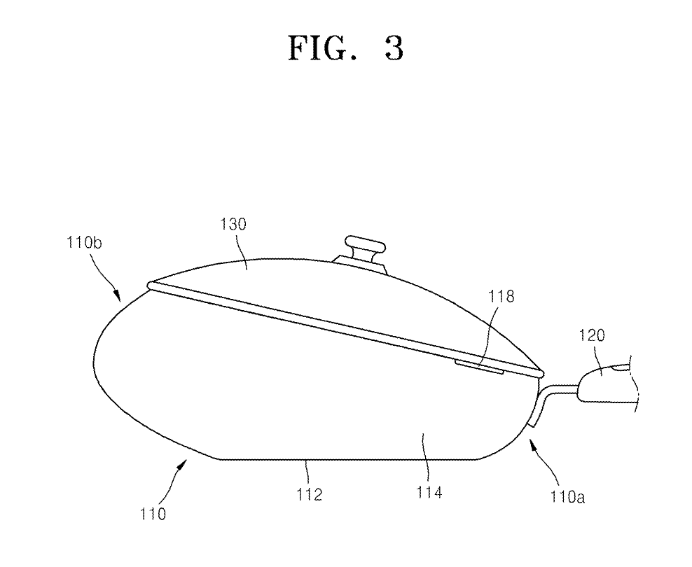

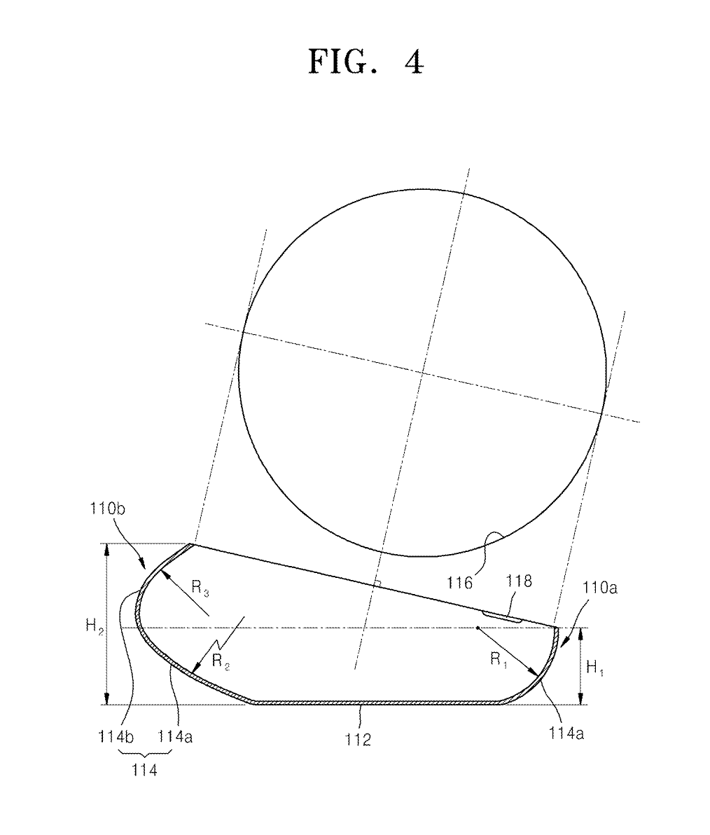

FIG. 1 is a perspective view of a multi-purpose cooking vessel according to an exemplary embodiment of the present invention. FIG. 2 is a plan view of the cooking vessel shown in FIG. 1, FIG. 3 is a side view of the cooking vessel shown in FIG. 2 with a lid on top, and FIG. 4 is a diagram showing a section of the vessel body according to A-A′ line shown in FIG. 2 together with the shape of an opening portion on the top of the sidewall.

Referring to FIGS. 1 through 4, the cooking vessel 100 according to an exemplary embodiment of the present invention is a vessel which is used to cook food, and is provided with a vessel body 110 which has a concave shape and a handle 120 which is attached to the external surface of the vessel body 110.

The vessel body 110 is made of a metal material such as aluminum or stainless steel, and has a shape which can be used for multiple purposes such as a frying pan, a stir fry pan, a roasting pan, a pot, etc.

In detail, the vessel body 110 includes a bottom plate 112 which is formed to be flat, and a sidewall 114 which is formed on the circumference of the bottom plate 112.

The bottom plate 112 may be formed as a circle with a predetermined diameter.

The sidewall 114 is formed to be inclined such that the height of sidewall 114 gradually increases from a first side 110A of the vessel body 110 toward a second side 110B located opposite to the first side 110A with respect to the center of the vessel body 110.

In detail, the sidewall 114 includes a lower sidewall 114A which is extended upwardly and rounded externally from the circumference of the bottom plate 112, and an upper sidewall 114B which is extended upwardly from the top of the lower sidewall 114A and bent rounded internally toward inside of the vessel body 110. The upper sidewall 114B efficiently prevents overflowing of food inside the vessel body 110. While the lower sidewall 114A is formed to have a uniform height, the height of the upper sidewall 114B is formed to gradually increase from the first side 110A of the vessel body 110 toward the second side 110B. Accordingly, the top edge of the sidewall 114, as shown in FIG. 4, is formed to be inclined such that the height H1 of the first side 110A is the lowest and the height H2 of the second side 110B is the highest.

As shown in FIG. 4, an opening portion 116 of the top of the sidewall 114 is formed to be circular. Accordingly, as shown in FIG. 3, a lid 130 which is generally manufactured to have a circle shape can cover the opening portion 116 of the top of the sidewall 114.

As described above, since the lid 130 can be used for the cooking vessel 100 according to the exemplary embodiment of the present invention, the cooking vessel 100 can be used as a pot to boil or simmer foods, and in this case, by using the lid 130, loss of heat can be reduced and overflow of food can be prevented. Also, the cooking vessel 100 can be used as a frying pan, a stir fry pan and a roasting pan, and in this case, by using the lid 130, spattering or overflowing of cooking oil or food can be prevented.

In the cooking vessel 100 according to the exemplary embodiment of the present invention, since the upper sidewall 114B of the vessel body 110 is formed to have a shape bent rounded inwardly to the inside of the vessel body 110, when the cooking vessel 100 is used as a frying pan, a stir fry pan or a roasting pan, spattering or overflowing of cooking oil or food can be more efficiently prevented.

Also, the height H2 of the sidewall 114 of the second side 110B of the vessel body 110 is high, but the height H1 of the sidewall 114 of the first side 110A is low. Accordingly, the sidewall 114 does not prevent use of a turner or scoop and thus food can be cooked easily.

In the present embodiment, as shown in FIG. 4, a second radius of curvature R2 of the lower sidewall 114A of the second side 110B may be formed to be greater than a first radius of curvature R1 of the lower sidewall 114A of the first side 110A of the vessel body 110. That is, the lower sidewall 114A located on the second side 110B of the vessel body 110 has a relatively bigger second radius of curvature R2 such that the sidewall 114A is smoothly extended from the circumference of the bottom plate 112. Accordingly, the radius of curvature of the lower sidewall 114A gradually increases from the first side 110A of the vessel body 110 toward the second side 110B and from the first radius of curvature R1 toward the second radius of curvature R2. Also, a third radius of curvature R3 of the upper sidewall 114B may be less than the second radius of curvature R2. Also, the second radius of curvature R2 may be a constant value, or a gradually varying value. That is, the second radius of curvature R2 may gradually decrease in the upward direction, and thus the inner surface of the lower sidewall 114A and the inner surface of the upper sidewall 114B may be smoothly connected. Meanwhile, the first and third radiuses R1 and R3 may also be varying values.

As described above, the lower sidewall 114A located at the second side 110B of the vessel body 110 has the relatively bigger second radius of curvature R2 to be smoothly connected from the circumference of the bottom plate 112, and the upper sidewall 114B formed on top of the sidewall 114A has the relatively smaller third radius of curvature R3. When the cooking vessel 110 is used as a frying pan or roasting pan, if the food is pushed to the sidewall 114 side by using a turner or scoop, the food is pushed up along the inner surface of the lower sidewall 114A and is easily turned on the upper sidewall 114B. Accordingly, by the cooking vessel 100 of the present embodiment, food inside the vessel body 110 can be easily turned by using a turner or scoop.

Also, as the heat transfer area is widened by the lower sidewall 114B which is formed to have a gentle slope, food is evenly heated and cooked appropriately, and thus the taste of the food is improved.

In the present embodiment, the handle 120 may be attached to the external surface of the vessel body 110 by using a plurality of rivets or by welding, and may have a variety of shape in addition to the shape shown in FIG. 1.

The handle 120 may be attached to any location on the external surface of the vessel body 110. Considering easiness of handling of the vessel body 110, the handle 120 may be attached to the external surface of the lower sidewall 114A located on the first side 110A of the vessel body 110 having the lowest height. Also, when the diameter of the vessel body 110 is relatively big, two handles 120 may be attached with an interval on the circumference of the vessel body 110 for much easier handling.

On the top of the sidewall 114 of the vessel body, a discharge spout 118 may be formed to discharge food to the outside.

In the present embodiment, the discharge spout 118 may be formed to be close to the first side 110A where the handle 120 is attached to. In detail, the discharge spout 118 may be formed such that the angle between a first straight line S1 which connects the center of the vessel body 110 and the center of the handle 120, and a second straight line S2 which connects the center of the vessel body and the center of the discharge spout 118 is between 30° and 60° inclusive. Also, the discharge spout 118 may be formed on both sides of the first side 110A of the vessel body 110.

As described above, the discharge spout 118 is formed to be close to the first side 110A of the vessel body 110 to which the handle 120 is attached and which has the lowest height, and thus, if the vessel body 110 is tilted just a little, the food inside the vessel body 110 is discharged to the outside. That is, after the vessel body 110 is a little tilted in the direction of the handle 120 and if the vessel body 110 is tilted just a little in the direction of the first side, the food in the vessel body 110 can be easily discharged to the outside through the discharge spout 118, and thus effort required for discharging food is reduced and user convenience increases compared to discharge spouts formed on other locations.

A method of manufacturing the cooking vessel 100 according to the exemplary embodiment of the present invention will now be explained.

The present applicant manufactured the cooking vessel 100 having the above-described structure by using a method similar to a conventional manufacturing method of a general cooking vessel, and experienced many problems which are explained in the following comparison examples.

### COMPARISON EXAMPLES OF THE MANUFACTURING METHOD

### <First Manufacturing Method>

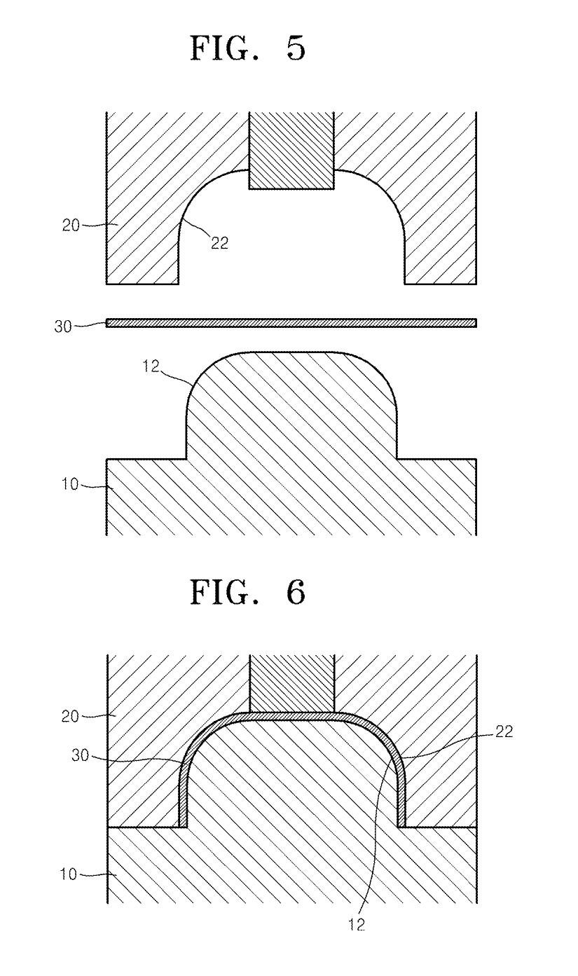

FIGS. 5 through 8 are diagrams to show an example of a method of manufacturing the cooking vessel shown in FIGS. 1 through 4.

First, as shown in FIG. 5, a metal plate 30 is provided between a lower mold 10 and an upper mold 20. On the lower mold 10 and the upper mold 20, a lower pressing surface 12 and an upper pressing surface 22 having shapes corresponding to each other are formed respectively.

Then, as shown in FIG. 6, if the upper mold 20 is lowered, the metal plate 30 is pressed and transformed between the lower pressing surface 12 of the lower mold 10 and the upper pressing surface 22 of the upper mold 20, and the vessel body 110 as shown in FIG. 7 with a concave shape is formed. At this time, the vessel body 110 has a flat bottom plate 112 and a sidewall 114 formed on the circumference of the bottom plate 112, and the top part of the sidewall 114 is formed to be vertical and to have a predetermined height.

Next, the top portion of the sidewall 114 of the vessel body 110 is cut to be inclined. At this time, the cutting is repeatedly performed several times along the cutting lines L shown in FIG. 7 such that the top edge of the sidewall 114 is inclined. Accordingly, the cutting tool is caught intermittently to the sidewall 114 and an impact is momentarily delivered to the cutting tool every time. According to this, the cutting tool may be damaged and the cut top surface of the sidewall 114 is formed to be not smooth.

Also, a large part of the sidewall 114 is cut and thrown away, and thus loss of the material is great. The cutting of the top portion of the sidewall 114 should be repeated many times, and thus processing time increases and manufacturing cost increases.

Finally, as shown in FIG. 8, by using a bending mold (not shown), the top part of the sidewall 114 of the vessel body 110 is bent rounded inwardly to the inside of the vessel body 110 and thus, the upper sidewall 114B is formed. At this time, the higher part of the sidewall 114 is bent more than other parts.

However, as described above, the top part of the sidewall 114 of the vessel body 110 is cut to be inclined and the top part of the higher part of the sidewall 114 is bent more, and thus, the opening on top of the sidewall 114 is formed not as a circle shape, but as an oval shape. Like this, if the opening portion on the top of the sidewall is formed to be oval, a lid which is generally circular cannot be used, and thus the manufactured cooking vessel cannot be used as a pot.

The present applicant also provides an exemplary embodiment to solve these problems of the manufacturing method described above. The exemplary embodiment of the method of manufacturing the cooking vessel 100 shown in FIGS. 1 through 4 as will be explained below.

### <An Exemplary Embodiment of the Manufacturing Method>

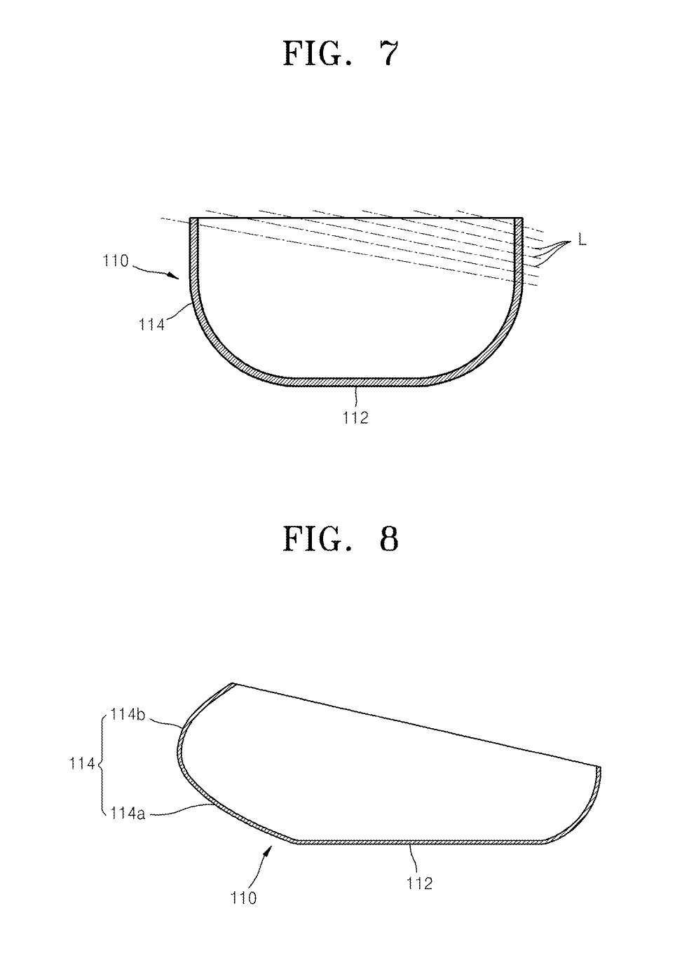

FIGS. 9 through 14 show diagrams explaining an exemplary embodiment of the method of manufacturing the cooking vessel shown in FIGS. 1 through 4.

FIG. 9 is a sectional view of a lower mold and an upper mold to form the vessel body of the cooking vessel shown in FIGS. 1 through 4.

Referring to FIG. 9, a lower mold 210 and an upper mold 220 for forming the vessel body 110 of the cooking vessel 100 according to the exemplary embodiment of the present invention are provided.

On the lower mold 210, a convex lower pressing surface 212 is formed. The lower pressing surface 212 may include a flat surface portion 212A which has a flat circle shape, a curved surface portion 212B which is extended downwardly and rounded from the circumference of the flat surface portion 212A, and a vertical surface portion 212C which is extended vertically and downwardly from the bottom of the curved surface portion 212B.

On the upper mold 220, a concave upper pressing surface 222 is formed to have a shape corresponding to the shape of the lower pressing surface 212 of the lower mold 210. At the center of the upper mold 220, a core 224 is provided on a location corresponding to the flat surface portion 212A of the lower pressing surface 212 such that the core 224 moves up and down, and the diameter of the bottom surface of the core 224 is the same as that of the flat surface portion 212A.

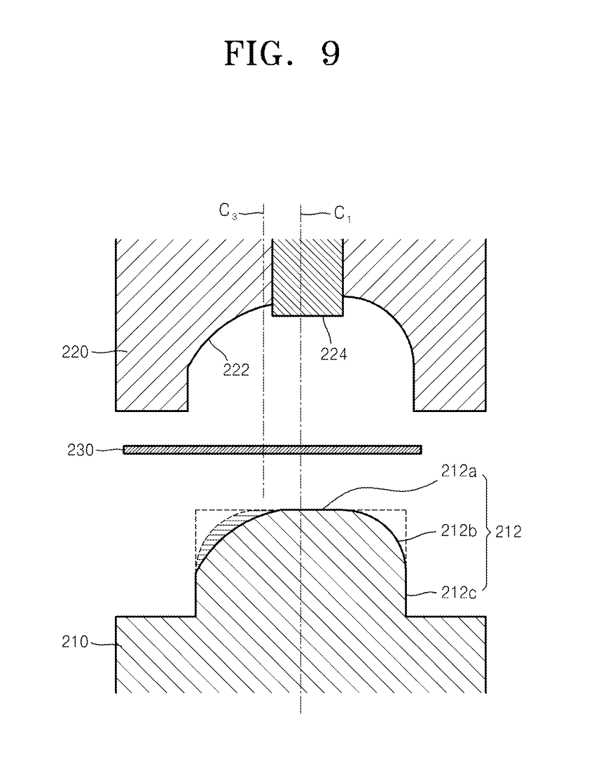

The lower mold 210 may be manufactured by a method which is explained below, and FIG. 10 is a diagram to explain a method of forming the lower pressing surface 212 of the lower mold 210 shown in FIG. 9.

Referring to FIG. 10, by processing the top surface of a material M for the lower mold 210 to be flat, the flat surface portion 212A is formed, and by processing the circumference of the material M, the vertical surface portion 212C with a predetermined diameter is formed.

Then, the circumference of the flat surface portion 212A of the material M is first processed to be rounded with respect to a first center line C1 of the lower mold 210, and thus, the curved surface portion 212B formed with a first processing surface F1 is formed. At this time, the curved surface portion 212B is formed to have a predetermined first radius of curvature R1, and the flat surface portion 212A is formed to have a first diameter D1.

Next, the circumference of the flat surface portion 212A of the material M is second processed to have a second radius of curvature R2 which is greater than the first radius of curvature R1, with respect to a second center line C2 which is eccentrically moved to a predetermined distance from the first center line C1 of the lower mold 210 toward the first side 210A of the lower mold 210. At this time, the bottom of the second processing surface F2 which is formed by the second processing coincides with the bottom of the first processing surface F1 on the second side 210B of the lower mold 210.

Then, the distance between the first center line C1 and the second center line C2, that is, the eccentric movement distance, may vary according to the diameter of the vessel body 110 and the difference between the first and second radiuses of curvature R1 and R2. For example, the distance may be determined in a range from approximately 10 mm to 50 mm inclusive, but it is not limited by this range.

Thus, since the second center line C2 which is the center of the second processing is eccentric to the first center line C1, the first side 210A of the lower mold is not processed by cutting, and cutting gradually increases from the first side 210A towards the second side 210B, and the flat surface portion 212A is reduced to have the second diameter D2 which is shorter than the first diameter D1.

Meanwhile, the upper pressing surface 222 of the upper mold 220 may be formed by the same method as that for forming the lower pressing surface 212 explained above. However, since the upper pressing surface 222 is formed to be concave, the order of processing will be changed.

Referring again to FIG. 9, a metal plate 230 such as aluminum or stainless steel is placed between the provided lower mold 210 and upper mold 220. At this time, the metal plate 230 is placed such that a third center line C3 of the metal plate 230 is eccentrically moved a predetermined distance from the first center line C1 of the lower mold toward the second side 210B of the lower mold 210. At this time, the distance between the first center line C1 of the lower mold 210 and the third center line C3 of the metal plate 230, that is, the eccentric movement distance, may vary according to the diameter of the vessel body 110 and, for example, may be determined in a range from approximately 10 mm to 50 mm inclusive, but is not limited to this range.

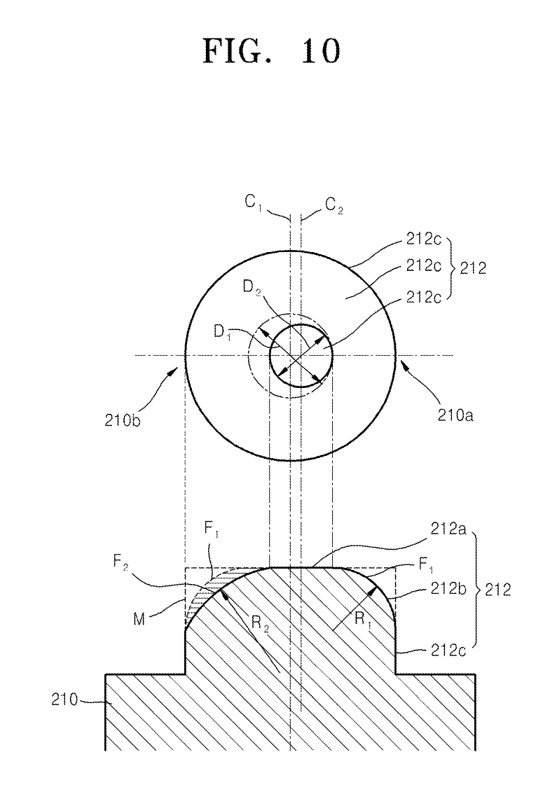

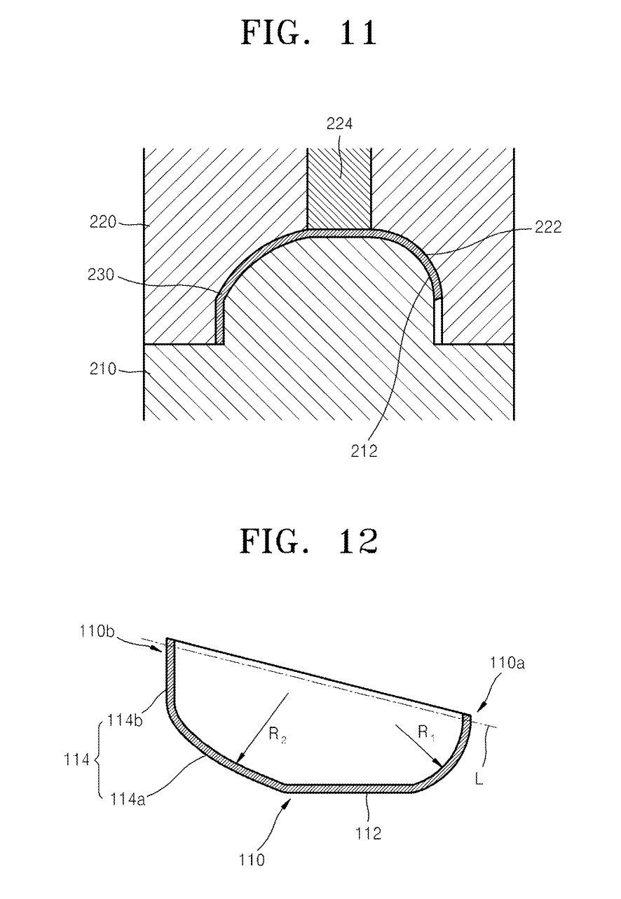

FIG. 11 is a diagram showing a state in which a metal plate is pressed and transformed between the lower mold and the upper mold shown in FIG. 9, and FIG. 12 is a sectional view of the vessel body formed by the process shown in FIG. 11.

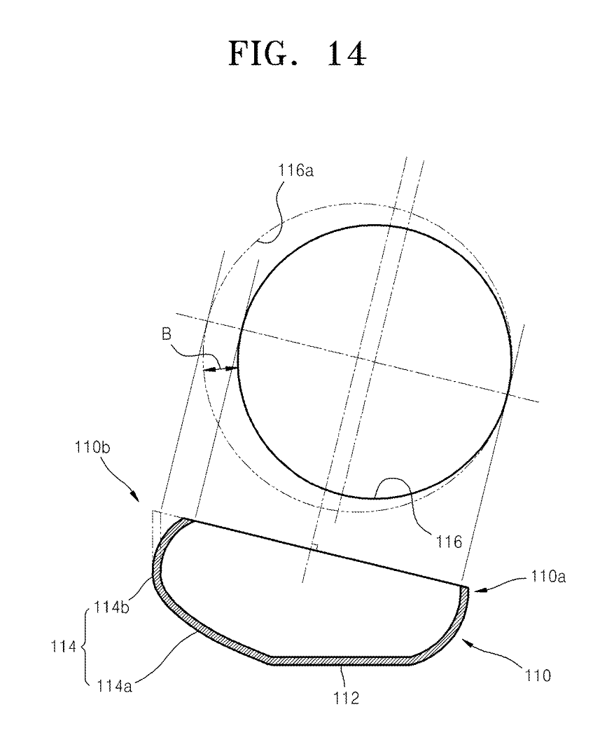

Referring to FIG. 11, a core 224 of the upper mold 220 is lowered and thus, immobilizes the metal plate 230 between the top surface of the lower mold 210 and the bottom surface of the core 224. Then, if the upper mold 220 is lowered, the metal plate 230 is pressed and transformed between the lower pressing surface 212 of the lower mold 210 and the upper pressing surface 222 of the upper mold 220, and thus, the vessel body 110 with a concave shape as shown in FIG. 12 is formed. At this time, as described above, since the metal plate 230 is eccentrically moved toward the second side 210B of the lower mold 210, the height of the sidewall 114 located on the first side 110A of the vessel body 110 is lower and the height of the sidewall 114 located on the second side 110B is higher, the top edge of the sidewall 114 is formed to be inclined. Also, the shape of the opening portion of the top of the sidewall 114 of the vessel body 110 may be formed to be a circle as shown in FIG. 14.

The vessel body 110 thus formed has the flat bottom plate 112 and the sidewall 114 formed on the circumference of the bottom plate 112. The lower sidewall 114A of the sidewall 114 is formed to be rounded with the first or second radius of curvature R1 or R2, and the upper sidewall 114B is formed to be extended vertically and upwardly.

Next, the top part of the sidewall 114 of the vessel body 110 is cut along the cutting line L to be inclined. At this time, as described above, since the top of the sidewall 114 of the vessel body 110 is already formed inclined, the top of the sidewall 114 can be cut with a smaller number of cutting times, for example, with only once or twice of cutting. Also, the problem that the cutting tool is caught intermittently to the sidewall 114 which is explained above in the comparison examples is solved.

Further, as the cutting amount of the sidewall 114 is minimized, loss of material is reduced and the number of times of cutting processing is also reduced and thus, processing hours decrease and the size of the metal plate 230 to be used can be reduced, and thus manufacturing costs decrease.

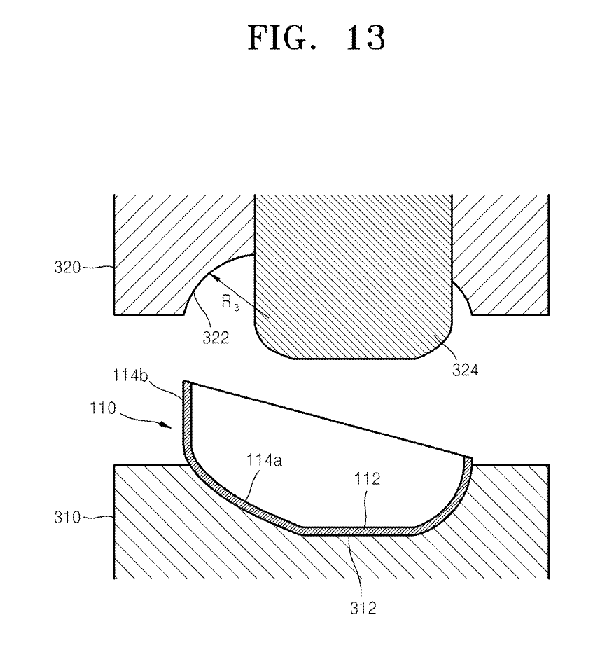

FIG. 13 is a diagram to explain a process for bending the top part of the sidewall of the vessel body shown in FIG. 12, and FIG. 14 is a diagram showing a section of the vessel body and the shape of the opening portion on the top of the sidewall, completed through the bending process shown in FIG. 13.

Referring to FIG. 13, a lower bending mold 310 and an upper bending mold 320 are provided.

On the top surface of the lower bending mold 310, a concave support surface 312 is formed, and with the support surface 312, the bottom plate 112 of the vessel body 110 and the lower sidewall 114A are in contact.

On the bottom surface of the upper bending mold 320, a concave bent surface 322 is formed, and at the center of the bent surface 322, a core 324 is provided on a location corresponding to the bottom plate 112 of the vessel body 110 which is stably placed on the support surface 212 of the lower bending mold 210. The core 324 presses and immobilizes the bottom plate 112 of the vessel body 110, and thus prevents moving of the vessel body 110 in a bending process which is explained below. The bent surface 322 is for bending the upper part of the sidewall 114 of the vessel body 110 such that the upper part is bent rounded toward inside of the vessel body 110. The bent surface 322 is formed to have the same radius of curvature as the third radius of curvature R3 of the upper sidewall 114B shown in FIG. 4. The bottom surface of the core 324 may be formed to have a shape to be in tight contact with the bottom plate 112 of the vessel body 110 and part of the lower sidewall 114A.

In this state, if the upper bending mold 320 is lowered, the upper part of the sidewall 114 of the vessel body 110 is pressed and bent by the bent surface 322 of the upper bending mold 320, such that the upper part is bent rounded toward the inside of the vessel body 110 as shown in FIG. 14. At this time, since the top of the sidewall 114 of the vessel body 110 is formed to be inclined, bending of the top part does not occur on the first side 110A of the vessel body 110, and on the second side 110B of the vessel body, the top part of the sidewall 114 is bent the most to form the upper sidewall 114B. That is, the amount B of bending of the top part of the sidewall 114 gradually increases from the first side 110A of the vessel body 110 toward the second side 110B.

A circle expressed by an alternated long and short dash line in FIG. 14 denotes the shape of the opening portion 116 on the top of the sidewall 114 before the bending process, and may be formed to be a circle with a predetermined diameter as described above. In this state, if the bending process is performed, as described above, the amount B of bending of the top part of the sidewall 114 gradually increases from the first side 110A of the vessel body 110 toward the second side 110B, and thus, the opening portion 116 of the top of the sidewall 114 after the bending process is formed to also have a circle shape with a reduced diameter.

As described above, according to the manufacturing method of the exemplary embodiment, the opening portion 116 on the top of the sidewall 114 of the vessel body 110 can be more easily formed to be a circle.

Finally, as shown in FIG. 2, the discharge spout 118 is formed on the top of the sidewall 114 of the vessel body 110 and the handle 120 is attached to the external surface of the sidewall 114 of the vessel body 110, and thus the cooking vessel 100 according to the exemplary embodiment of the present invention is manufactured.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art the various changes in form and details may be made therein without departing from the spirit and scope of the present invention as defined by the following claims.

1. A cooking vessel comprising:
a vessel body which has a concave shape; and
a handle which is attached to an external surface of the vessel body,
wherein the vessel body comprises:
a bottom plate which is formed flat; and
a sidewall which is formed on the circumference of the bottom plate, the sidewall comprising:
a lower sidewall which is formed from the circumference of the bottom plate and is extended upwardly and rounded externally; and
an upper sidewall which is extended upwardly from the top of the lower sidewall and bent rounded internally toward inside of the vessel body, and
the top edge of the upper sidewall is formed inclined such that the height of the upper sidewall gradually increases from a first side of the vessel body toward a second side of the vessel body located opposite to the first side with respect to the center of the vessel body, and
an opening portion of the top of the sidewall is formed to have a circle shape;
wherein the lower sidewall of the first side of the vessel body is formed to have a first radius of curvature and the lower sidewall of the second side of the vessel body is formed to have a second radius of curvature which is greater than the first radius of curvature,
wherein a discharge spout for discharging food to the outside is formed on the top edge of the sidewall close to the handle, and
wherein an angle between a first straight line which connects the center of the vessel body and the center of the handle, and a second straight line which connects the center of the vessel body and the center of the discharge spout is between 30° and 60° inclusive.

2. (canceled)

3. The cooking vessel of claim 2, wherein the upper sidewall is formed to have a third radius of curvature which is less than the second radius of curvature.

4-5. (canceled)

6. A method of manufacturing a cooking vessel with a vessel body which has a concave shape and a handle which is attached to an external surface of the vessel body, the method comprising:
preparing a lower mold which has a convex lower pressing surface;
preparing an upper mold which has a concave upper pressing surface whose shape corresponds to the shape of the convex lower pressing surface;
placing a metal plate between the lower mold and the upper mold such that the center line of the metal plate is moved eccentrically from the center line of the lower mold;
forming a vessel body by lowering the upper mold and thus pressing and transforming the metal plate in order to form the vessel body having a flat bottom plate and a sidewall formed on the circumference of the bottom plate, wherein forming the vessel body further comprises:
forming the sidewall to have a lower sidewall which is formed from the circumference of the bottom plate and is extended upwardly and rounded externally; and
forming an upper sidewall which is extended perpendicularly to the top of the lower sidewall and of which the top edge is formed inclined such that the height of the upper sidewall gradually increases from a first side of the vessel body toward a second side of the vessel body located opposite to the first side with respect to the center of the vessel body;
processing the top portion of the sidewall of the vessel body to be inclined;
bending the upper sidewall such that the upper sidewall is rounded internally toward the inside of the vessel body and an opening portion of the top of the sidewall has a circle shape; and
attaching the handle to the external surface of the vessel body.

7. The method of claim 6, wherein the preparing the lower mold which has the convex lower pressing surface further comprises:
preparing a flat surface portion which is flat;
preparing a curved surface portion which is extended downwardly and rounded from the circumference of the flat surface portion; and
preparing a vertical surface portion which is extended vertically and downwardly from the bottom of the curved surface portion.

8. The method of claim 7, wherein the preparing of the lower mold comprises:
forming the flat surface portion by processing the top surface of a material for the lower mold to be flat;
forming the vertical surface portion by processing the circumference of the material; and
forming the curved surface portion by processing the material on the circumference of the flat surface portion to be rounded, and
the forming of the curved surface portion comprises: a first processing for processing the material on the circumference of the flat surface portion to be rounded and have a first radius of curvature with respect to the center line of the lower mold; and
a second processing for processing the material on the circumference of the flat surface portion to be rounded and have a second radius of curvature with respect to a center line which is moved eccentrically from the center line of the lower mold to a first side of the lower mold, and the second radius of curvature is greater than the first radius of curvature.

9. The method of claim 8, wherein in a second side of the lower mold, the bottom of a second processing surface which is formed in the second processing coincides with the bottom of the first processing surface which is formed in the first processing, and
in the first processing, the flat surface portion is limited to have a first diameter and in the second processing, and the flat surface portion is reduced to have a second diameter which is shorter than the first diameter.

10. The method of claim 6, wherein at the center of the upper mold, a core is provided on a location corresponding to the flat surface portion of the convex lower pressing surface such that the core moves up and down, and
in the forming of the vessel body, the core immobilizes the metal plate between the top surface of the lower mold and the bottom surface of the core.

11. The method of claim 6, wherein the bending of the upper sidewall comprises:
preparing a lower bending mold which has a concave support surface supporting the vessel body;
preparing an upper bending mold which has a concave bending surface for bending the upper sidewall;
stably placing the vessel body on the support surface of the lower bending mold; and
lowering the upper bending mold and thus pressing the upper sidewall of the vessel body with the bent surface such that the upper sidewall is bent rounded inwardly to the inside of the vessel body.

12. The method of claim 11, further comprising:
at the center of the upper bending mold, providing a core on a location corresponding to the bottom plate of the vessel body stably placed on the support surface of the lower bending mold, and
in the bending of the upper sidewall, pressing and immobilizing the bottom plate of the vessel body by the core.

13. The method of claim 6, further comprising:
attaching the handle to the external surface of the first side of the vessel body, and
before attaching the handle, forming a discharge spout for discharging food on the top edge of the sidewall close to the first side of the vessel body.
